(19) United States
(12) Patent Application Publication
(10) Pub. No.: US 2021/0250451 A1
(43) Pub. Date: Aug. 12, 2021

(54) DISPLAY CONTROL DEVICE AND NON-TRANSITORY COMPUTER READABLE MEDIUM

(71) Applicant: FUJI XEROX CO., LTD., Tokyo (JP)

(72) Inventor: Shigeo MIYATA, Kanagawa (JP)

(73) Assignee: FUJI XEROX CO., LTD., Tokyo (JP)

(21) Appl. No.: 17/020,741

(22) Filed: Sep. 14, 2020

(30) Foreign Application Priority Data
Feb. 6, 2020 (JP) 2020-019033

(51) Int. Cl. H04N 1/00

(52) U.S. Cl. CPC H04N 1/00413; H04N 1/00129; H04N 1/00204; G06F 3/041; H04N 1/00488; H04N 1/00973; H04N 1/00411

(57) ABSTRACT

A display control device includes a processor. When names of plural first apparatuses that are installed at different installation locations are displayed on a display unit of a second apparatus, and the names displayed in a display area of the display unit contain the same character string, the processor performs control for displaying, together with the names, information items that enable determination as to which installation location each of the first apparatuses is installed.

### CROSS-REFERENCE TO RELATED APPLICATIONS

This application is based on and claims priority under 35 USC 119 from Japanese Patent Application No. 2020-019033 filed Feb. 6, 2020.

### BACKGROUND

### (i) Technical Field

The present disclosure relates to a display control device and a non-transitory computer readable medium.

### (ii) Related Art

Japanese Unexamined Patent Application Publication No. 2017-182292 discloses a terminal device including an acquisition unit that acquires, from a printing apparatus, identification information that identifies the printing apparatus via near field communication and a display control unit. In the case where a printing apparatus whose identification information has been acquired by the acquisition unit is included in results of search for printing apparatuses, when the printing apparatuses included in the search results are displayed as a list, the display control unit displays the printing apparatus, whose identification information has been acquired, such that the printing apparatus is distinguishable from the other printing apparatuses in the list.

When the names of a plurality of first apparatuses that are installed at different locations are displayed on a display unit of a second apparatus, if the names that are displayed in a display area of the display unit contain the same character string, it is difficult to determine which location each of the plurality of first apparatuses displayed on the display unit of the second apparatus is installed.

### SUMMARY

Aspects of non-limiting embodiments of the present disclosure relate to facilitating determination as to which location each of a plurality of first apparatuses that are displayed on a display unit of a second apparatus is installed compared with the configuration in which control is always performed in such a manner that only the names of the first apparatuses are displayed on the display unit of the second apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a display control device including a processor. When names of a plurality of first apparatuses that are installed at different installation locations are displayed on a display unit of a second apparatus, and the names displayed in a display area of the display unit contain the same character string, the processor performs control for displaying, together with the names, information items that enable determination as to which installation location each of the first apparatuses is installed.

### BRIEF DESCRIPTION OF THE DRAWINGS

Exemplary embodiments of the present disclosure will be described in detail based on the following figures, wherein:

FIG. 1 a schematic diagram illustrating an example of the configuration of an information processing system according to a first exemplary embodiment;

FIG. 2 a schematic diagram illustrating an example of display contents of a display unit of one of first apparatuses according to the first exemplary embodiment;

FIG. 3 a schematic diagram illustrating a state where a color assigned to one of the first apparatuses according to the first exemplary embodiment is used as the background color of the display unit;

FIG. 4 a block diagram illustrating an example of the hardware configuration of a second apparatus according to the first exemplary embodiment;

FIG. 5 a schematic diagram illustrating an example of display contents of a display unit of the second apparatus according to the first exemplary embodiment;

FIG. 6 a schematic diagram illustrating a display example when the names of the first apparatuses displayed on the display unit illustrated in FIG. 5 exceed a display area;

FIG. 7 a block diagram illustrating an example of the functional configuration of the second apparatus according to the first exemplary embodiment;

FIG. 8 a schematic diagram illustrating a display example of the display unit illustrated in FIG. 5 when colors each of which is assigned beforehand to one of the first apparatuses are used in the backgrounds of the names of the corresponding first apparatuses;

FIG. 9 a flowchart illustrating a flow of display control processing that is performed by the second apparatus according to the first exemplary embodiment;

FIG. 10 a schematic diagram illustrating a state where a symbol that is assigned to one of first apparatuses according to a second exemplary embodiment is displayed on a display unit;

FIG. 11 a schematic diagram illustrating a display example of a display unit of a second apparatus according to the second exemplary embodiment when symbols each of which is assigned beforehand to one of the first apparatuses are displayed together with the names of the corresponding first apparatuses;

FIG. 12 a schematic diagram illustrating a display example of a display unit of a second apparatus according to a third exemplary embodiment when operation buttons each of which is used for causing one of a plurality of first apparatuses to generate sound are displayed together with the names of the corresponding first apparatuses; and

FIG. 13 a schematic diagram illustrating the states of the plurality of first apparatuses when one of the operation buttons according to the third exemplary embodiment is operated.

### DETAILED DESCRIPTION

Exemplary embodiments of the present disclosure will be described below with reference to the drawings.

### «First Exemplary Embodiment»

### (Information Processing System 10)

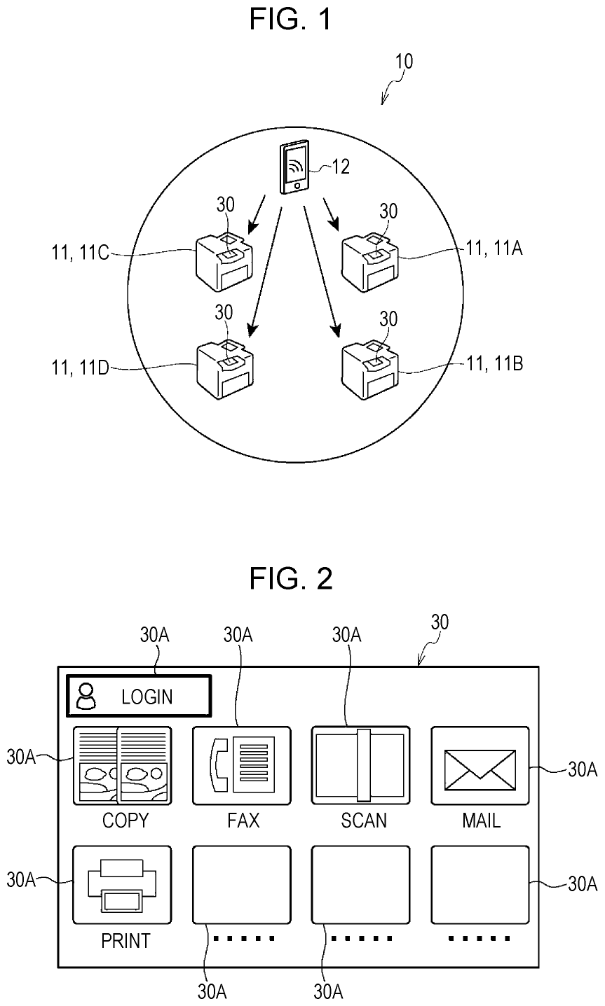

An example of the configuration of information processing system 10 according to the first exemplary embodiment will be described first. FIG. 1 is a schematic diagram illustrating the configuration of the information processing system 10 according to the present exemplary embodiment.

The information processing system 10 is a system that processes information and includes a plurality of first apparatuses 11 and a second apparatus 12 as illustrated in FIG. 1. The specific configuration of each of the plurality of first apparatuses 11 and the specific configuration of the second apparatus 12 will be described below.

Note that, although FIG. 1 illustrates four first apparatuses 11A, 11B, 11C, and 11D as the plurality of first apparatuses 11, the number of first apparatuses 11 is not limited.

### (First Apparatuses 11)

As an example, each of the first apparatuses 11 illustrated in FIG. 1 is an execution apparatus that executes a process instructed by a user. Specifically, each of the first devices 11 is an image forming apparatus that executes an image forming process instructed by a user. More specifically, each of the first apparatuses 11 is a multifunction machine configured to execute various processes such as copying, facsimile communication, scanning, and printing that are instructed by a user. Note that, the first apparatuses 11 are not limited to multifunction machines, and for example, a printer or the like that executes a printing process or an image forming apparatus that is not a multifunction machine may be used as each of the first apparatuses 11. In addition, the first apparatuses 11 are not limited to image forming apparatuses and may be personal computers, and an execution apparatus that is not an image forming apparatus may be used as each of the first apparatuses 11.

As illustrated in FIG. 1, each of the first apparatuses 11 includes a display unit 30 (see FIG. 2) that displays various information items. As an example, each of the display units 30 is formed of a touch-screen display. As illustrated in FIG. 2, each of the display units 30 displays various information items and input units 30A through which various input operations are performed by a user. The input units 30A include instruction buttons (so-called icons) that are used for instructing execution of various processes.

The plurality of first apparatuses 11 illustrated in FIG. 1 are installed at different locations. The plurality of first apparatuses 11 are capable of communicating with one another by a wireless communication system such as Wi-Fi or Bluetooth (Registered Trademark). In other words, the plurality of first apparatuses 11 are installed at different locations within an area in which the plurality of first apparatuses 11 are capable of communicating with one another by using their wireless communication functions.

Note that each of the plurality of first apparatuses 11 and the second apparatus 12 are also capable of communicating with each other by a wireless communication system such as Wi-Fi or Bluetooth (Registered Trademark).

In the case where the plurality of first apparatuses 11 have the same name, different colors are each set to one of the first apparatuses 11 as an identifier. More specifically, the identifiers are set in the following manner.

When one of the first apparatuses 11 (hereinafter referred to as “installing apparatus”) is installed, this installing apparatus searches for another first apparatus 11 (hereinafter referred to as “installed apparatus”) that has already been installed in a wirelessly communicable area.

When an installed apparatus is found as a result of the search performed by the installing apparatus, a color that is not used by the installed apparatus is assigned to the installing apparatus as an identifier of the installing apparatus. The colors that are assigned to the plurality of first apparatuses 11 are different from one another. More specifically, in the present exemplary embodiment, for example, blue, orange, green, and purple are assigned to the first apparatuses 11A, 11B, 11C, and 11D, respectively. Note that, when no installed apparatus is found as a result of the search performed by the installing apparatus, an arbitrary color is assigned to the installing apparatus as an identifier of the installing apparatus.

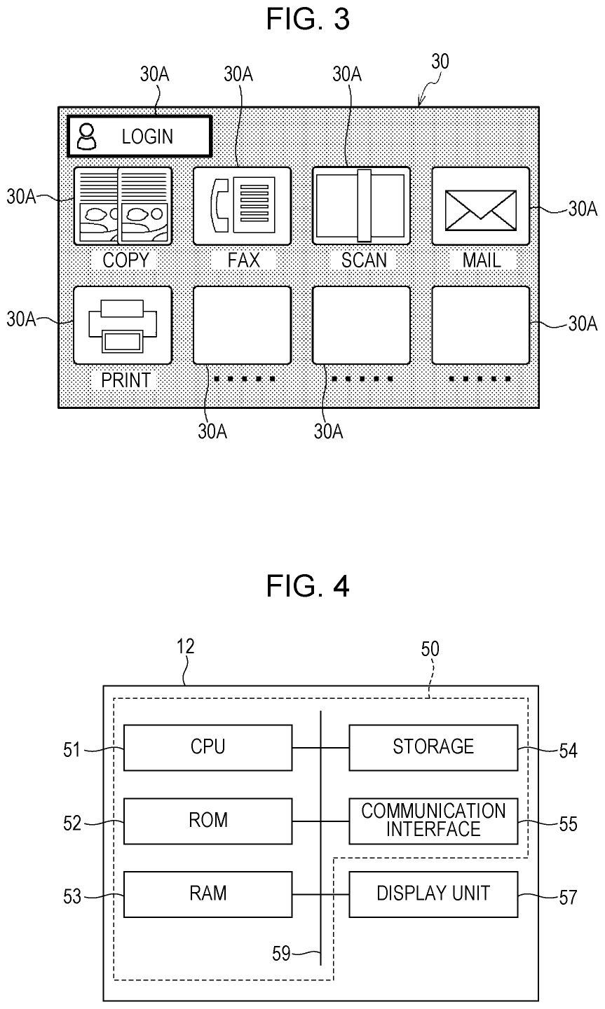

As illustrated in FIG. 3, the installing apparatus uses the color, which has been assigned thereto as its identifier, in the background of the display unit 30. In other words, the installing apparatus displays the background of the display unit 30 with the color, which has been assigned thereto as its identifier.

### (Second Apparatus 12)

As an example, the second apparatus 12 illustrated in FIG. 1 is a terminal that is used by a user. Specifically, for example, an apparatus that is able to be carried by a user is used as the second apparatus 12. More specifically, for example, a tablet personal computer, a smartphone, a cellular phone, or the like is used as the second apparatus 12. Note that, the second apparatus 12 is not limited to an apparatus that is able to be carried by a user, and for example, any one of various apparatuses such as a stationary personal computer may be used as the second apparatus 12.

As described above, the second apparatus 12 is capable of communicating with the plurality of first apparatuses 11 by a wireless communication system such as Wi-Fi or Bluetooth (Registered Trademark). The second apparatus 12 is an apparatus that is capable of instructing execution of various processes to the first apparatuses 11.

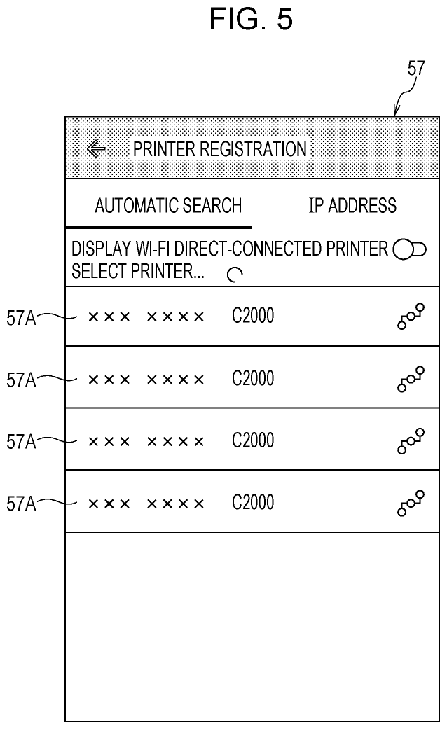

FIG. 4 is a block diagram illustrating the hardware configuration of the second apparatus 12. The second apparatus 12 includes a display unit 57 (see also FIG. 5) and a display control device 50 that performs display control on the display unit 57. The display control device 50 has a function of serving as a computer and includes a CPU (processor) 51, read only memory (ROM) 52, random access memory (RAM) 53, a storage 54, and a communication interface 55 as illustrated in FIG. 4. These units of the display control device 50 and the display unit 57 are connected to one another via a bus 59 so as to be capable of communicating with one another.

The CPU 51 is a central processing unit that runs various programs including a display control program and controls each unit. In other words, the CPU 51 reads a program from the ROM 52 or the storage 54 and runs the program by using the RAM 53 as a work area.

The ROM 52 stores various programs and various data items. The RAM 53 serves as a work area and temporarily stores a program or a data item. The storage 54 is formed of a storage unit such as a hard disk drive (HDD) or a solid state drive (SSD) and stores various programs including an operating system and various data items. The communication interface 55 is an interface for communicating with other devices such as the first apparatuses 11.

FIG. 5 illustrates an example of a screen (a display form) of the display unit 57. As an example, the display unit 57 illustrated in FIG. 5 is formed of a touch-screen display. As illustrated in FIG. 5, the display unit 57 displays various information items and input units 57A through which various input operations are performed by a user.

More specifically, in FIG. 5, selection buttons each of which is used for selecting one of the plurality of first apparatuses 11 that is to be instructed to execute various processes are used as the input units 57A. In other words, the screen illustrated in FIG. 5 is an example of a selection screen on which the plurality of selection buttons are displayed as the input units 57A.

In each of the plurality of input units 57A, the name of one of the first apparatuses 11 (specifically, “xxx xxxx C2000”) is displayed in the horizontal writing style (i.e., in a display form in which characters are displayed by being arranged side by side). The display unit 57 displays the input units 57A by stacking them vertically on top of one another in the selection screen. As a result, the names of the plurality of first apparatuses 11 are displayed in a list in the selection screen illustrated in FIG. 5.

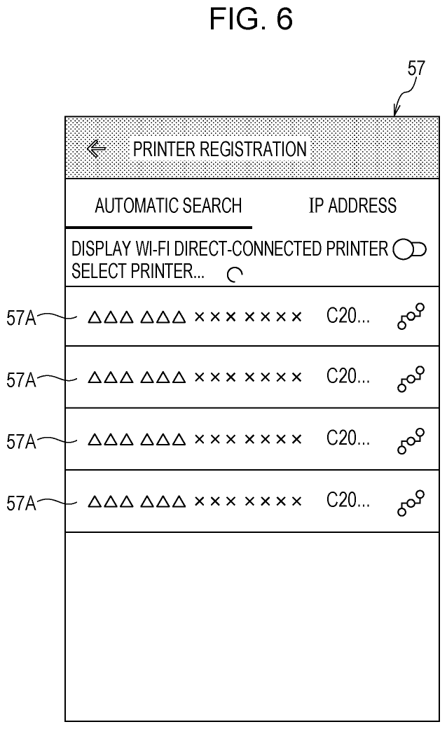

In the display unit 57, a display area of each of the input units 57A in which the name of a corresponding one of the plurality of first apparatuses 11 is displayed is predetermined. More specifically, in the display unit 57, the length of the display area of each of the input units 57A in the transverse direction is set to a predetermined length. Thus, when the names of the first apparatuses 11 exceed the display areas, as an example, portions of the names are displayed in the display area of the display unit 57 as illustrated in FIG. 6. In other words, when the names exceed the display areas, portions of the names are not displayed. Note that FIG. 6 illustrates the case in which a portion of the name of each of the first apparatuses 11, which is “AAA AAA xxx xxxx C2000”, is not displayed.

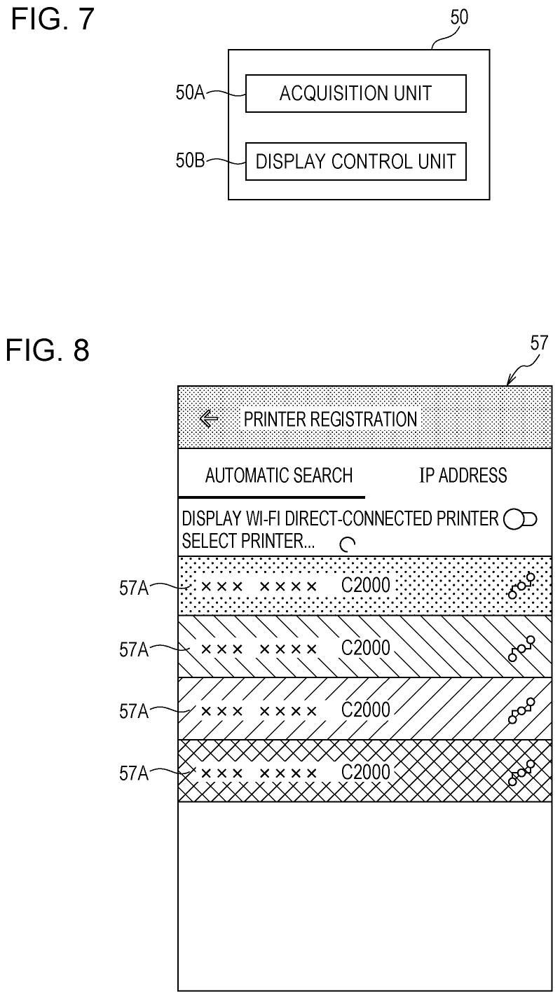

When running the above-mentioned programs, the display control device 50 obtains various functions by using the above-mentioned hardware resources. A functional configuration that is obtained by the display control device 50 will be described below. FIG. 7 is a block diagram illustrating an example of the functional configuration of the display control device 50.

As illustrated in FIG. 7, the display control device 50 includes, as its functional components, an acquisition unit 50A and a display control unit 50B. Each of the functional components is constructed as a result of the CPU 51 reading and running the display control program stored in the ROM 52 or the storage 54.

The acquisition unit 50A acquires name information items that indicate the names of the plurality of first apparatuses 11. In the present exemplary embodiment, the acquisition unit 50A acquires, from the first apparatuses 11 arranged in an area in which the first apparatuses 11 are capable of wirelessly communicating with the second apparatus 12, the name information items related to these first apparatuses 11.

When the names of the plurality of first apparatuses 11 that are displayed on the display unit 57 of the second apparatus 12 include the same character string in a display area of the display unit 57, the display control unit 50B performs control for displaying, together with the names of the first apparatuses 11, information items (hereinafter referred to as “identifiable information items”) that enable determination as to which locations the first apparatuses 11 are installed.

More specifically, when the names of the plurality of first apparatuses 11 that are displayed on the display unit 57 of the second apparatus 12 are the same as one another in the display area of the display unit 57, the display control unit 50B performs control for displaying the identifiable information items together with the names.

The display control unit 50B performs control for displaying, as the identifiable information items, identifiers each of which is assigned beforehand to one of the plurality of first apparatuses 11. The identifiers are specifically colors each of which is used in the background of the display unit 30 of a corresponding one of the plurality of first apparatuses 11, and these colors are different from one another.

Specifically, the display control unit 50B performs control for displaying the backgrounds of the names of the first apparatuses 11 in the corresponding colors, which are the identifiers, as illustrated in FIG. 8. More specifically, the display control unit 50B performs control for using blue, orange, green, and purple, which are assigned to the first apparatuses 11A, 11B, 11C, and 11D, respectively, as the background colors of the names of the first apparatuses 11A, 11B, 11C, and 11D. Note that, in FIG. 8, blue is indicated by a dot pattern, orange is indicated by a pattern of diagonal lines from top left to bottom right, green is indicated by a pattern of diagonal lines from top right to bottom left, and purple is indicated by a pattern of crossing diagonal lines.

In the present exemplary embodiment, when the names of the plurality of first apparatuses 11 that are displayed on the display unit 57 of the second apparatus 12 are different from one another in the display area of the display unit 57, the display control unit 50B performs control for not displaying the identifiable information items but displaying the names.

### (Effects of First Exemplary Embodiment)

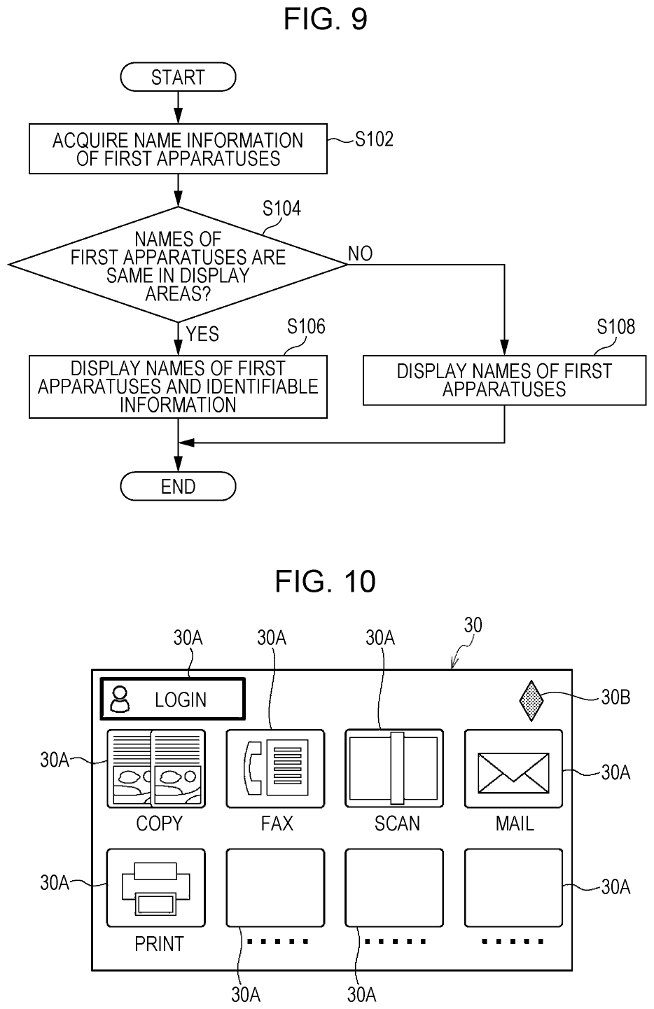

Exemplary effects of the first exemplary embodiment will now be described. FIG. 9 is a flowchart illustrating a flow of display control processing that is performed by the display control device 50.

The display control processing is performed as a result of the CPU 51 reading and running the display control program stored in the ROM 52 or the storage 54. For example, the display control processing is started when a user issues a display instruction to the second apparatus 12 for causing the display unit 57 of the second apparatus 12 (see FIG. 5) to display the selection screen.

First, as illustrated in FIG. 9, the CPU 51 acquires the name information items that indicate the names of the plurality of first apparatuses 11 (step S102).

Next, when the names of the plurality of first apparatuses 11 are displayed on the display unit 57 of the second apparatus 12, the CPU 51 determines whether the names are the same as one another in the display area of the display unit 57 (step S104).

When it is determined that the names of the plurality of first apparatuses 11 are the same as one another in the display area of the display unit 57 (YES in step S104), the CPU 51 performs control for causing the display unit 57 to display the identifiable information items together with the names (step S106).

More specifically, as illustrated in FIG. 8, the CPU 51 causes the backgrounds of the names of the first apparatuses 11A, 11B, 11C, and 11D to be displayed in blue, orange, green, and purple, which are respectively assigned to the first apparatuses 11A, 11B, 11C, and 11D, as the identifiable information items.

On the other hand, when it is determined that the names of the plurality of first apparatuses 11 are different from one another in the display area of the display unit 57 (NO in step S104), the CPU 51 causes the display unit 57 not to display the identifiable information items but to display the names as illustrated in FIG. 5 (step S108).

As described above, in the present exemplary embodiment, when the names of the plurality of first apparatuses 11 that are displayed on the display unit 57 of the second apparatus 12 are the same as one another in the display area of the display unit 57, the CPU 51 performs control for displaying the identifiable information items together with the names.

As a result, a user may easily determine which location each of the plurality of first apparatuses 11 displayed on the display unit 57 is installed (hereinafter referred to as “determination of the installation locations of the first apparatuses 11”) by referencing to the identifiable information items (specifically, the colors of the backgrounds of the display unit 57) and selecting each of the first apparatuses 11. Thus, according to the present exemplary embodiment, determination of the installation locations of the first apparatuses 11 may easily be performed compared with the configuration in which control is always performed in such a manner that only the names of the first apparatuses 11 are displayed on the display unit 57 of the second apparatus 12.

In particular, in the present exemplary embodiment, since the CPU 51 performs control for displaying the identifiable information items together with the names of the first apparatuses 11 when the names are the same as one another in the display area of the display unit 57, in a situation in which it is difficult to perform determination of the installation locations of the first apparatuses 11, the determination of the installation locations of the first apparatuses 11 may be easily and effectively performed compared with the configuration in which the CPU 51 performs control for displaying the information items also when the names of the plurality of first apparatuses 11 are different from one another.

In the present exemplary embodiment, the CPU 51 performs control for displaying, as the identifiable information items, the identifiers each of which is assigned beforehand to one of the plurality of first apparatuses 11.

Thus, determination of the installation locations of the first apparatuses 11 may be easily performed compared with the configuration in which information items other than the identifiers that are assigned beforehand to the corresponding first apparatuses 11, are displayed.

The identifiers displayed on the display unit 57 are specifically the colors each of which is used in the background of the display unit 30 of a corresponding one of the plurality of first apparatuses 11, and these colors are different from one another.

Thus, determination of the installation locations of the first apparatuses 11 may be performed with higher viewability compared with the configuration in which identifiers other than the colors used in the backgrounds of the display unit 57 are used.

### «Second Exemplary Embodiment»

The second exemplary embodiment will now be described. Note that components that are the same as those in the first exemplary embodiment are denoted by the same reference signs, and descriptions thereof will be suitably omitted.

In the above-described first exemplary embodiment, although the identifiers that are displayed on the display unit 57 are the different colors each of which is assigned to one of the plurality of first apparatuses 11 and each of which is used in the background of the display unit 30 of the corresponding first apparatus 11, identifiers in the second exemplary embodiment have the following configuration.

In other words, in the second exemplary embodiment, identifiers that are displayed on the display unit 57 are symbols of different shapes each of which is assigned to one of the plurality of first apparatuses 11 and displayed on the display unit 30 of the corresponding first apparatus 11. As an example, symbols having shapes such as a diamond shape, a heart shape, a spade shape, and a clover shape are used.

In the present exemplary embodiment, when the names of the plurality of first apparatuses 11 are the same as one another, symbols of different shapes are each set to one of the plurality of first apparatuses 11 as an identifier. More specifically, the identifiers are set in the following manner.

When one of the first apparatuses 11 (hereinafter referred to as “installing apparatus”) is installed, this installing apparatus searches for another first apparatus 11 (hereinafter referred to as “installed apparatus”) that has already been installed in a wirelessly communicable area.

When an installed apparatus is found as a result of the search performed by the installing apparatus, a symbol that is not used by the installed apparatus is assigned to the installing apparatus as an identifier of the installing apparatus. Note that, when no installed apparatus is found as a result of the search performed by the installing apparatus, an arbitrary symbol is assigned to the installing apparatus as an identifier of the installing apparatus. As illustrated in FIG. 10, the display unit 30 of the installing apparatus displays a symbol 30B that is assigned to the installing apparatus as the identifier. Note that FIG. 10 illustrates a case where a symbol having a diamond shape is used as the symbol 30B.

In the present exemplary embodiment, when the names of the plurality of first apparatuses 11 that are displayed on the display unit 57 of the second apparatus 12 are the same as one another in the display area of the display unit 57, the display control unit 50B performs control for displaying the identifiable information items together with the names.

The display control unit 50B performs control for displaying, as the identifiable information items, the identifiers each of which is assigned beforehand to one of the plurality of first apparatuses 11. The identifiers are specifically the symbols of different shapes each of which is displayed on the display unit 30 of a corresponding one of the plurality of first apparatuses 11.

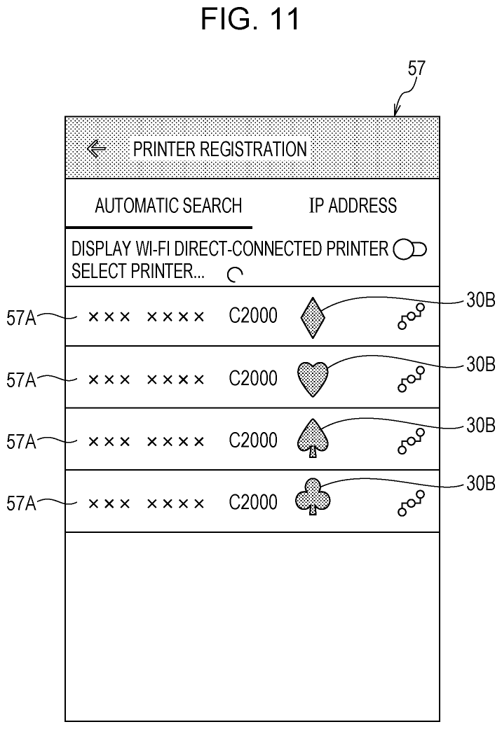

Specifically, as illustrated in FIG. 11, the display control unit 50B performs control for displaying the symbols, which function as the identifiers, together with the names of the first apparatuses 11. More specifically, the display control unit 50B performs control for displaying, together with the names of the first apparatuses 11A, 11B, 11C, and 11D, symbols 30B each of which has one of diamond, heart, spade, and clover shapes and each of which is assigned to one of the first apparatuses 11A, 11B, 11C, and 11D.

In the present exemplary embodiment, when the names of the plurality of first apparatuses 11 that are displayed on the display unit 57 of the second apparatus 12 are different from each other in the display area of the display unit 57, the display control unit 50B performs control for not displaying the identifiable information but displaying the names.

### (Effects of Second Exemplary Embodiment)

Effects of the second exemplary embodiment will now be described.

Also in the second exemplary embodiment, the display control processing is performed as in the case illustrated in FIG. 9. In other words, when it is determined that the names of the plurality of first apparatuses 11 are the same as one another in the display area of the display unit 57 (YES in step S104), the CPU 51 causes the display unit 57 to display the identifiable information items together with the names in step S106.

Here, in the second exemplary embodiment, as illustrated in FIG. 11, the symbols of diamond, heart, spade, and clover shapes each of which is assigned to one of the first apparatuses 11A, 11B, 11C, and 11D are displayed as the identifiable information items together with the names of the first apparatuses 11A, 11B, 11C, and 11D.

As a result, a user may easily perform determination of the installation locations of the first apparatuses 11 by referencing to the identifiable information items (specifically, the symbols) and selecting each of the first apparatuses 11. Thus, according to the present exemplary embodiment, determination of the installation locations of the first apparatuses 11 may easily be performed compared with the configuration in which control is always performed in such a manner that only the names of the first apparatuses 11 are displayed on the display unit 57 of the second apparatus 12.

In the second exemplary embodiment, as described above, the identifiers that are displayed on the display unit 57 are the symbols of different shapes each of which is displayed on the display unit 30 of a corresponding one of the first apparatuses 11.

Thus, determination of the installation locations of the first apparatuses 11 may be performed with higher viewability compared with the configuration in which identifiers other than the symbols that are displayed on the display unit 57 are used.

### «Third Exemplary Embodiment»

The third exemplary embodiment will now be described. Note that components that are the same as those in the first exemplary embodiment are denoted by the same reference signs, and descriptions thereof will be suitably omitted.

In the above-described first exemplary embodiment, although the display control unit 50B performs control for displaying, as the identifiable information items, the identifiers each of which is assigned beforehand to a corresponding one of the plurality of first apparatuses 11, the display control unit 50B in the third exemplary embodiment has the following configuration.

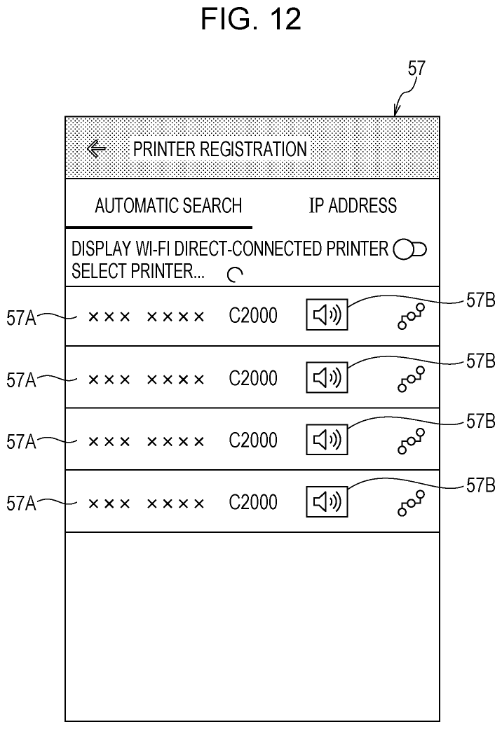

In other words, in the third exemplary embodiment, as illustrated in FIG. 12, the display control unit 50B performs control for displaying, as identifiable information items, operation buttons 57B that are used for causing the plurality of first apparatuses 11 to generate sound.

### (Effects of Third Exemplary Embodiment)

Effects of the third exemplary embodiment will now be described.

Also in the third exemplary embodiment, the display control processing is performed as in the case illustrated in FIG. 9. In other words, when it is determined that the names of the plurality of first apparatuses 11 are the same as one another in the display area of the display unit 57 (YES in step S104), the CPU 51 causes the display unit 57 to display the identifiable information items together with the names in step S106.

Here, in the third exemplary embodiment, as illustrated in FIG. 12, the CPU 51 causes the operation buttons 57B, which are used for causing the plurality of first apparatuses 11 to generate sound, to be displayed as identifiable information items together with the names of the first apparatuses 11.

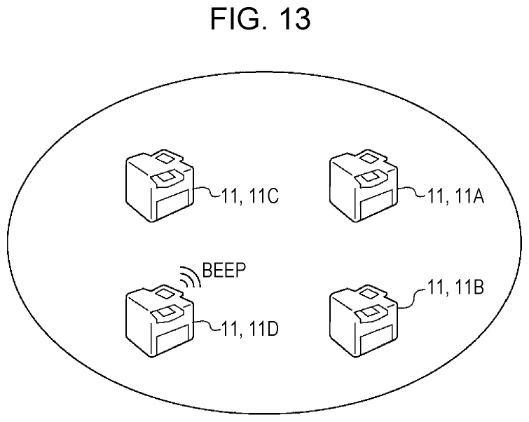

As a result, a user operates one of the operation buttons 57B, so that one of the first apparatuses 11 that corresponds to the operation button 57B generates sound as illustrated in FIG. 13. This facilitates determination of the installation locations of the first apparatuses 11. Therefore, according to the present exemplary embodiment, determination of the installation locations of the first apparatuses 11 may easily be performed compared with the configuration in which control is always performed in such a manner that only the names of the first apparatuses 11 are displayed on the display unit 57 of the second apparatus 12.

In the third exemplary embodiment, as described above, the operation buttons 57B that are used for causing the plurality of first apparatuses 11 to generate sound are displayed as the identifiable information items together with the names of the first apparatuses 11, and thus, determination of the installation locations of the first apparatuses 11 may be performed by using the sense of hearing.

In addition, in the present exemplary embodiment, the display control unit 50B may perform control for displaying, as information items, the operation buttons 57B that are used for causing the plurality of first apparatuses 11 to generate different sounds. With this configuration, determination of the installation locations of the first apparatuses 11 may easily be performed compared with the configuration in which the sounds generated by the plurality of first apparatuses 11 are the same as one another.

### (Modifications)

In the present exemplary embodiment, when it is determined that the names of the plurality of first apparatuses 11 are the same as one another in the display area of the display unit 57 (YES in step S104), the CPU 51 causes the display unit 57 to display the identifiable information items together with the names (step S106). However, the present disclosure is not limited to this configuration.

For example, when the names of the plurality of first apparatuses 11 that are displayed in the display area of the display unit 57 contain the same word (YES in step S104), the CPU 51 may cause the display unit 57 to display the identifiable information items together with the names.

When the names of the plurality of first apparatuses 11 that are displayed in the display area of the display unit 57 at least contain the same character string (YES in step S104), the CPU 51 may cause the display unit 57 to display the identifiable information items together with the names.

Note that the term “word” is a minimum unit that has grammatical meaning and function and that has independence in language usage. The term “character string” is a unit smaller than a word and is a string of characters formed of a plurality of characters. A character string does not need to have a grammatical meaning or function.

In the present exemplary embodiment, although the display control device 50 is included in the second apparatus 12, the present disclosure is not limited to this configuration. For example, the display control device 50 may be included in an external apparatus that is installed outside the second apparatus 12. An example of this external apparatus is a server apparatus that is capable of communicating with the second apparatus 12.

The present disclosure is not limited to the above-described exemplary embodiments, and various modifications, changes, and improvements may be made within the gist of the present disclosure. For example, the above-described modifications may be suitably combined with one another.

In the embodiments above, the term “processor” refers to hardware in a broad sense. Examples of the processor include general processors (e.g., CPU: Central Processing Unit), and dedicated processors (e.g., GPU: Graphics Processing Unit, ASIC: Application Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A display control device comprising:
a processor,
wherein, when names of a plurality of first apparatuses that are installed at different installation locations are displayed on a display unit of a second apparatus, and the names displayed in a display area of the display unit contain the same character string, the processor performs control for displaying, together with the names, information items that enable determination as to which installation location each of the first apparatuses is installed.

2. The display control device according to claim 1,
wherein the processor performs control for displaying, as the information items, identifiers each of which is assigned beforehand to one of the plurality of first apparatuses.

3. The display control device according to claim 2,
wherein the identifiers are different colors each of which is used in a background of a display unit of a corresponding one of the plurality of first apparatuses.

4. The display control device according to claim 2,
wherein the identifiers are symbols of different shapes each of which is displayed on a display unit of a corresponding one of the plurality of first apparatuses.

5. The display control device according to claim 1,
wherein the processor performs control for displaying, as the information items, operation buttons that are used for causing the plurality of first apparatuses to generate sound.

6. The display control device according to claim 2,
wherein the processor performs control for displaying, as the information items, operation buttons that are used for causing the plurality of first apparatuses to generate sound.

7. The display control device according to claim 3,
wherein the processor performs control for displaying, as the information items, operation buttons that are used for causing the plurality of first apparatuses to generate sound.

8. The display control device according to claim 4,
wherein the processor performs control for displaying, as the information items, operation buttons that are used for causing the plurality of first apparatuses to generate sound.

9. The display control device according to claim 5,
wherein the processor performs control for displaying, as the information items, operation buttons that are used for causing the plurality of first apparatuses to generate different sounds.

10. The display control device according to claim 6,
wherein the processor performs control for displaying, as the information items, operation buttons that are used for causing the plurality of first apparatuses to generate different sounds.

11. The display control device according to claim 7,
wherein the processor performs control for displaying, as the information items, operation buttons that are used for causing the plurality of first apparatuses to generate different sounds.

12. The display control device according to claim 8,
wherein the processor performs control for displaying, as the information items, operation buttons that are used for causing the plurality of first apparatuses to generate different sounds.

13. The display control device according to claim 1,
wherein the processor performs control for displaying the information items when the names displayed in the display area of the display unit contain the same word.

14. The display control device according to claim 2,
wherein the processor performs control for displaying the information items when the names displayed in the display area of the display unit contain the same word.

15. The display control device according to claim 3,
wherein the processor performs control for displaying the information items when the names displayed in the display area of the display unit contain the same word.

16. The display control device according to claim 4,
wherein the processor performs control for displaying the information items when the names displayed in the display area of the display unit contain the same word.

17. The display control device according to claim 5,
wherein the processor performs control for displaying the information items when the names displayed in the display area of the display unit contain the same word.

18. The display control device according to claim 9,
wherein the processor performs control for displaying the information items when the names displayed in the display area of the display unit contain the same word.

19. The display control device according to claim 13,
wherein the processor performs control for displaying the information items when the names displayed in the display area of the display unit are the same as one another.

20. A non-transitory computer readable medium storing a program causing a computer to execute a process for controlling display, the process comprising:
performing control for displaying, together with names of a plurality of first apparatuses that are installed at different installation locations, information items that enable determination as to which installation location each of the first apparatuses is installed when the names are displayed on a display unit of a second apparatus, and the names displayed in a display area of the display unit contain the same character string.
